(19) United States
(12) Patent Application Publication
(10) Pub. No.: US 2025/0059098 A1
(43) Pub. Date: Feb. 20, 2025

(54) Inorganic liquid crystal media for the development of materials with electrical, magnetic, or catalytic properties

(71) Applicant: Joseph C. Magnotti, Tampa, FL (US)

(72) Inventor: Joseph C. Magnotti, Tampa, FL (US)

(21) Appl. No.: 18/445,442

(22) Filed: Aug. 17, 2023

(51) Int. Cl. C04B 35/50; C04B 35/01; C04B 35/447; C04B 35/48; C04B 35/515; C04B 35/553; C04B 35/653; C09K 19/04

(52) U.S. Cl. CPC C04B 35/50; C04B 35/01; C04B 35/447; C04B 35/48; C04B 35/5152; C04B 35/553; C04B 35/653; C09K 19/04; C04B 2235/3244; C04B 2235/443; C04B 2235/444; C04B 2235/445; C04B 2235/447; C04B 2235/448

(57) ABSTRACT

A method for the preparation of novel inorganic liquid crystals (LCs) is disclosed that results in the formation of lyotropic LCs with intermediate to long-range structural order, and which exhibit a magnetic anisotropy and other anisotropic properties that manifest as structural memory or integrity under phase transitions from solid to liquid and vice-versa.

### REFERENCES CITED

Hajjaj, F., et. al., “Rewriting the Phase Diagram of a Diamagnetic Liquid Crystal by a Magnetic Field”; Nat. Comm., 2018, 9, 4431 U.S. Pat. No. 6,540,939 B1; Martin et. al.

### TECHNICAL FIELD

This invention relates to the physical chemistry of inorganic liquid crystals, and more particularly a method for preparation of inorganic liquid crystals with anisotropic ordering.

### BACKGROUND OF THE INVENTION

A liquid crystal (LC) or mesogen is a state of matter whose properties are between those of a conventional liquid and those of solid crystals. An LC flows like a liquid, but its molecules are oriented in a crystal-like way, i.e. anisotropic ordering. There are three main types of liquid crystals: 1. Thermotropic, 2. Lyotropic, and 3. Metallotropic. Thermotropic LCs exhibit phase transition into the liquid phase as the temperature changes. Lyotropic LCs exhibit phase transition as a function of both temperature and the concentration of the components. Metallotropic LCs are composed of both organic and inorganic molecules and are not relevant to the instant application.

A true liquid is isotropic—its properties are uniform in all directions, which is the result of its molecules being in constant random (Brownian) motion. Solid-state crystals are anisotropic—optical, thermal, electrical, magnetic and other properties vary with direction. An LC has many of the physical and chemical attributes of a true liquid, such as fluidity and solvent capability, but its molecules are sufficiently ordered to retain aspects of the long-range order of a solid crystal.

Mesogens are compounds that display LC properties; they can be described as ordered liquids or disordered solids. The LC state is called a mesophase. Liquid crystal properties arise because mesogenic compounds are composed of both rigid and flexible parts. The rigid parts align the molecules in one direction. The flexible parts provide the mesogens with mobility.

IN 2018, F. Hajjaj, et. al. reported the effects of a 10 T magnetic field on the geometric lattice structure of a metallotropic liquid crystal, composed of an imidazolium bromide-appended paraffinic triphenylene, ^{Im}TPBr₆ (the organic component) and lanthanum (III) bromide (Hajjaj, F., et. al., Nat. Comm., 2018, 9, 4431). Their liquid crystals consisted of a discotic triphenylene core with six imidazolium bromide-terminated paraffinic side chains as a ligand complexed with LaBr₃. In the absence of a magnetic field, the LC assemblies exhibited a cubic, an orthorhombic, or a hexagonal columnar mesophase, depending on the content of LaBr₃ and the temperature. Specifically, samples of the LC, with a molar ratio (x) of LaBr₃ to the organic component of 0.7≤x≤1.3, were heated to 180° C. and allowed to cool to 27° C. Samples that had been immersed in a 10 T magnetic field as they cooled exhibited the cubic phase at 27° C. under powdered x-ray diffraction analysis (PXRD). Samples that had cooled in the absence of a magnetic field exhibited the ortho phase at 27° C. under PXRD analysis. When all of the samples were again heated and cooled in the absence of a magnetic field, they all exhibited the ortho phase at 27° C., indicating that the structural change induced by the magnetic field had been reversed upon reheating and cooling in the absence of a magnetic field.

The significance of the work of Hajjaj, et. al., is that it shows the effect of a magnetic field on the intermediate and long-range structural order of LCs. Their work did not report whether the phase change was retained when the LC was heated to temperatures below that of the isotropic liquid phase (i.e. 180° C.); however, in the present invention, once the structural order has been induced by a magnetic field during preparation, that order is retained upon subsequent heating and cooling at temperatures less than 100° C. (the boiling point of water) in the absence of a magnetic field.

Most of the known liquid crystalline materials are organic molecules or hybrid compositions comprising an inorganic component and an organic component; i.e. metallotropic LCs. The flexible segments of these organic and hybrid LCs are organic alkyl chains (surfactants) (see U.S. Pat. No. 6,540,939 B1; Martin et. al.; col. 4, lines 32-35). In the present invention, this flexibility is provided by hydrogen bonding between water molecule ligands attached to transition metal and rare-earth metal ions. “The observation of liquid crystallinity in inorganic systems is uncommon”, which “represents a significant deficiency in the art, particularly when inorganic liquid crystals could offer a range of unique properties by combining the fluid properties of liquid crystals with potential magnetic, conducting, dielectric, optical, redox and catalytic properties common to inorganic materials.” (U.S. Pat. No. 6,540,939 B1; Martin et. al.; col. 2, lines 7-8, 19-24). The present invention discloses a method for preparation of purely inorganic lyotropic liquid crystals which represents a significant improvement in the current state of the art.

### SUMMARY OF THE INVENTION

Lyotropic liquid crystals are disclosed, each comprised of two inorganic components in a ratio that provides intermediate to long-range structural order to the composition. Accordingly, it is an objective of the present invention to provide novel inorganic liquid crystals and glass compositions. It is another objective of the present invention to provide novel inorganic liquid crystals to serve as media, components, or matrix templates to aid in the development of materials with specific and desirable electrical, magnetic, dielectric, electrolytic, catalytic, or optical properties. Objectives of the invention having been stated hereinabove, other objectives will become evident as the description proceeds, when taken in connection with the accompanying Drawings and Laboratory Examples as best described hereinbelow.

### BRIEF DESCRIPTION OF THE DRAWINGS

References to Sample 1 in the drawings pertain to a sample of the stabilized liquid phase of the liquid crystal as prepared in the laboratory examples. References to Sample 2 in the drawings pertain to the solid phase of the same sample after destabilization and transition of the LC to the solid phase. (see Laboratory Examples 1 and 2 hereinbelow).

FIG. 1 and FIG. 2 show XRD data and the background curve for Samples 1 and 2, respectively.

FIG. 3 and FIG. 4 show the profile fitting results for Samples 1 and 2, respectively. FIG. 4A is a continuation of the data included with FIG. 4.

FIG. 5 compares the raw data from the two samples (Sample 1 was dried) after they were ground into powders.

FIG. 6 is a schematic depiction of the top view of the uniform-direction magnetic field into which the controls were inserted during preparation of the liquid crystals of the present invention. FIG. 7 is a schematic depiction of the top view of the nonuniform-direction magnetic field into which the liquid crystals of the present invention were successfully prepared. The numbers along the side of each of the drawings indicate the strength of the field line in milli Tesla (mT). The center of FIG. 7 has a field strength of 0 mT. The arrow marks on the field lines in FIG. 6 and FIG. 7 indicate the relative direction of the magnetic field along each line.

### DETAILED DESCRIPTION OF THE INVENTION

### A. Definitions

As used herein, the following terms are meant to have their art-recognized meanings.

### 1. Transition Metal Cations

The transition metals are listed in the periodic table of elements in groups 4 to 12 and comprise the elements of atomic number 22 to 30, 40 to 48, 72 to 80, and 104 to 112. As used herein, reference to transition metals or transition metal ions will include only the following elements: chromium (Cr), manganese (Mn), iron (Fe), cobalt (Co), nickel (Ni), copper (Cu), zinc (Zn), zirconium (Zr), palladium (Pd), and cadmium (Cd). References to transition metal ions in the present invention refer to their+2, +3, or +4 oxidation states, depending on the element.

### 2. Rare-Earth Metal Cations

The rare-earth metals are scandium (Sc), yttrium (Y), and the lanthanides, which are the elements listed in the periodic table of elements having atomic number 21, 39, and 57 to 71, respectively. As used herein, reference to rare-earth metals or rare-earth metal ions will include only the following elements: yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), and ytterbium (Yb). References to rare-earth metal ions in the present invention refer to the +3 oxidation state.

### 3. Other Relevant Terms

The terms inorganic, inorganic component, inorganic materials, etc. as used herein refer to substances that do not contain molecular compounds of the element carbon.

The terms intermediate or long-range structural order as used herein refer to any regular, 3-dimensional geometry of nanometer scale intrinsic to crystal lattices.

The term “structural memory” refers to a property of the liquid crystals in the present invention, whereby the LCs retain their intermediate or long-range order when transitioning in phase from glass or solid-state crystal to liquid crystal upon heating and when transitioning from liquid crystal to glass or solid-state crystal. Structural memory is analogous to a permanent magnet retaining its magnetization in the absence of an external magnetic field at temperatures below the Curie temperature.

The term “container” as used herein refers to a Pyrex glass vessel.

The term electrolyte as used herein refers to the solid or liquid medium necessary for ion transfer in electrical energy-storage batteries.

The term critical magnetic field as used herein refers to the strength or density of an externally applied magnetic field beyond which a superconductor loses its superconductivity, and the magnetic flux completely penetrates the material

The term superconductor as used herein refers to a material that exhibits zero electrical resistance and which expels externally applied magnetic fields from its bulk (the Meissner effect). The term Type II superconductor as used herein refers to a superconductor that has two critical magnetic fields, H1 and H2. An applied field lower than H1 is completely excluded from the bulk of the material. An applied field H where H1<H<H2 will partially penetrate the material, but zero electrical resistance is retained. A field strength beyond H2 results in complete penetration of the material by the magnetic field and breakdown of superconductivity.

The term medium or media as used herein refers to the chemical environment surrounding molecules or atoms as they mix and combine to form compounds or crystal lattices.

The term “matrix template” as used herein refers to a molecular scaffold or frame upon which molecules or atoms self-assemble or interact.

The term catalyst as used herein refers to any material that increases the rate of a chemical reaction without itself undergoing any permanent chemical change.

References to Eurofins EAG herein refer to Eurofins EAG Materials Science, 810 Kifer Rd., Sunnyvale, CA. 94086, Tel. (408)530-3829, an independent laboratory which furnishes chemical analysis services and which conducted XRD analyses of samples submitted by the Inventor of the materials disclosed in the present invention.

The term Rietveld Refinement as used herein refers to the technique developed by Hugo Rietveld for use in the characterization of crystalline materials, which uses the profile intensities of the composite peaks in XRD data in a pattern-fitting method of structure refinement.

The height, width, and position of the peaks is used to determine the intermediate to long-term structure of materials.

The term least squares mean as used herein refers to a form of mathematical regression analysis used to determine the line or curve of best fit for a set of experimental data.

The acronyms ICDD and ICSD as used herein refer to the International Center for Diffraction Database and the Inorganic Crystal Structure Database, respectively.

### B. General Considerations

The inorganic liquid crystals disclosed here are prepared from two solid-state components: a hydrated nitrate of a rare-earth metal and a hydrated salt of a transition metal. Each of the components are classified as coordination complexes, which are molecules having a central ion to which are attached one or more ligand molecules by coordination covalent bonds, also called dative bonds, in which both electrons in the covalent bond are provided by the same atom or molecule—i.e. the ligand. The molecular formulae of the starting components in the present invention are of the form R(NO₃)₃·6H₂O and TₓA_{y}·zH₂O, where R is a rare-earth metal cation with electrical charge +3, T is a transition metal cation with electrical charge +2, +3, or +4, and A is one of the following anions: sulfate SO₄⁻², nitrate NO₃⁻, chloride Cl⁻, fluoride F⁻, chlorate ClO₃⁻, arsenate AsO₄⁻³, phosphate PO₄⁻³, perchlorate ClO₄⁻, selenite SeO₃⁻², or tetrafluoroborate BF₄⁻. The quantities x=1, 2 or 3; y=1, 2, 3, or 4; and z=1 to 18, depending on the respective electrical charges on the cation and anion in the molecule. The ligands in each of the components are water molecules, which are subject to hydrogen bonding.

A hydrogen bond is an intermolecular force that forms a special dipole-dipole attraction when a hydrogen atom bonded to a strongly electronegative atom with a lone pair of valence electrons—i.e. oxygen (O), nitrogen (N), or fluorine (F)—is in the vicinity of another O, N, or F atom. Hydrogen bonds are weaker than covalent or ionic bonds, but the hydrogen bonds involving water molecules are almost as strong as coordinate or dative bonds; therefore, the hydrogen bonding in a liquid melt of the complex R(NO)₃·6H₂O is almost as strong as the coordination bonds between the H₂O ligands and the central R⁺³ ion, resulting in liquid crystals with a complicated and versatile chemistry. (see U.S. Pat. No. 6,540,939 B1; Martin et. al.; col. 8, lines 52-54).

The coordination number (CN) of a coordination complex corresponds to the number of ligand molecules bonded to the central ion. For R(NO)₃·6H₂O, CN=6, and for TₓA_{y}·zH₂O, CN=1 to 9. The coordination complexes with CN=1, 2 and 9 are rare. The number CN=1 is only possible when a large central metal ion is surrounded by a very bulky organic ligand. The geometry CN=2 is linear; CN=3 is trigonal planar; CN=4 is tetrahedral or square planar; CN=5 is trigonal bipyramidal or square pyramidal. For CN=6, the geometry is octahedral, and this is the most stable configuration for transition metal complexes. The liquid crystals disclosed here are composed of discrete octahedral molecular units in an intermediate to long-range structural order. (See U.S. Pat. No. 6,540,039 B1; Martin, et. al.; col. 9, lines 56-58). According to ligand field theory, the five d-block atomic orbitals of a transition metal ion, that are at the same energy (i.e. degenerate orbitals) in a spherically symmetric field, will not be at the same energy in the octahedral-shaped field imposed by the presence of the ligands. The effect of the octahedral ligand field is to split the d-orbitals into two sets whose energies differ by some ΔE, depending on the identity of the ligands. Such orbital splitting is also observed in spectroscopy during atomic absorption or emission measurements when the ionic sample being measured is immersed in an externally applied magnetic field (the Zeeman effect).

The LCs disclosed in the present invention exhibit a structural memory in their intermediate to long-range structural order, in that a phase change from liquid crystal to glass or solid-state crystal is reversible by melting the solid and restoring it to its original LC state with the integrity of the structural order unchanged. This structural memory is a function of hydrogen bonding between the discrete octahedral molecular units composing the LC and the magnetic anisotropy of the liquid crystal lattice.

### X-Ray Diffraction Analysis Report

Purpose: Use x-ray diffraction to identify the phase(s) present, determine the percent crystallinity, average crystallite size and texture orientation, if possible, in both a liquid and solid sample. The samples were identified as indicated in Table 1.

### Results:

TABLE 1
Phase identification, Lattice constants, Crystallite size and % Crystallinity

| | | Average | |
|---|---|---|---|
| | | crystallite | % |
| Sample ID | Phases Identified | size (nm) | Crystallinity |
| Sample 1 | Amorphous materials | N/A | N/A |
| (as is Liquid) | | | |
| Sample 1 | La(NO₃)₃(H₂O)₆—Lanthanum | 148.0 +/− 5.5 | 100.0% |
| (dried and | Nitrate Hydrate, with | | |
| ground | a ~ 8.9259 (14.5) Å | | |
| crystals) | b ~ 10.7063 (14.5) Å | | |
| | c ~ 6.6489 (14.5) Å | | |
| | Triclinic, S.G.: P-1 (2) | | |
| | [PDF# 04-011-0397] | | |
| Sample 2 | Unindexing pattern | N/A | N/A |
| (as is Solid) | | | |
| Sample 2 | La(NO₃)₃(H₂O)₆—Lanthanum | 110.7 +/− 2.1 | 100.0% |
| (Ground | Nitrate Hydrate, with | | |
| solids) | a ~ 8.9216 (8.8) Å | | |
| | b ~ 10.7035 (8.8) Å | | |
| | c ~ 6.6480 (8.6) Å | | |
| | Triclinic, S.G.: P-1 (2) | | |
| | [PDF# 04-011-0397] | | |

### C. Composition of the Preferred Embodiments

In accordance with the present invention, the nature of the inorganic components is the primary variable upon which the structural order of the materials disclosed here depends. A melted solid crystalline coordination complex of molecular formula R(NO₃)₃·6H₂O is used as a solvent, where R represents a cation from one of the following elements: yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), and ytterbium (Yb). These rare-earth nitrates provide an appropriate solvent for the preparation of the LCs in the present invention, as they all melt at a temperature less than the boiling point of water (100° C.).

TABLE 2
Melting Points of Selected Rare-Earth Metal Nitrates (°C.)

| | | | |
|---|---|---|---|
| Y(NO₃)₃•6H₂O | 51.8 | Dy(NO₃)₃•6H₂O | 88.6 |
| La(NO₃)₃•6H₂O | 69.9 | Yb(NO₃)₃•6H₂O | 51.8 |
| Ce(NO₃)₃•6H₂O | 65.0 | Ho(NO₃)₃•6H₂O | 91.5 |
| Eu(NO₃)₃•6H₂O | 65.0 | Nd(NO₃)₃•6H₂O | 40.0 |
| Pr(NO₃)₃•6H₂O | 58.0 | Gd(NO₃)₃•6H₂O | 91.0 |
| Tb(NO₃)₃•6H₂O | 89.3 | Sm(NO₃)₃•6H₂O | 78.5 |

At temperatures less than 100° C., the integrity of the structure of the coordination complexes, with their ligands of H₂O, remains undisturbed. A solid-state crystalline coordination complex of molecular formula TₓA_{y}·zH₂O is added as a solute to the melted rare-earth metal nitrate to the point of saturation—i.e. when the solute no longer dissolves. T is a transition metal cation with electrical charge +2, +3, or +4, and A is one of the following anions: sulfate SO₄⁻², nitrate NO₃⁻, chloride Cl⁻, fluoride F⁻, chlorate ClO₃⁻, arsenate AsO₄⁻³, phosphate PO₄⁻³, perchlorate ClO₄⁻, selenite SeO₃⁻², or tetrafluoroborate BF₄⁻. The quantities x=1, 2 or 3; y=1, 2, 3, or 4; and z=1 to 18, depending on the respective electrical charges on the cation and anion in the molecule. The ligands in each of the components are water molecules, which are subject to hydrogen bonding. The resulting solution of hydrated transition metal salt in hydrated rare-earth metal nitrate is heated to 90° C., and the liquid is separated from excess hydrated transitional metal salt and poured into a second container already immersed in a magnetic field (see FIG. 7 and the laboratory examples herein below). The solution in the second container will be approximately 40:1 by weight of hydrated rare-earth metal nitrate to hydrated transition metal salt.

### D. Laboratory Examples

### Laboratory Example 1: Copper (II) Sulfate Pentahydrate in Lanthanum (III) Nitrate Hexahydrate

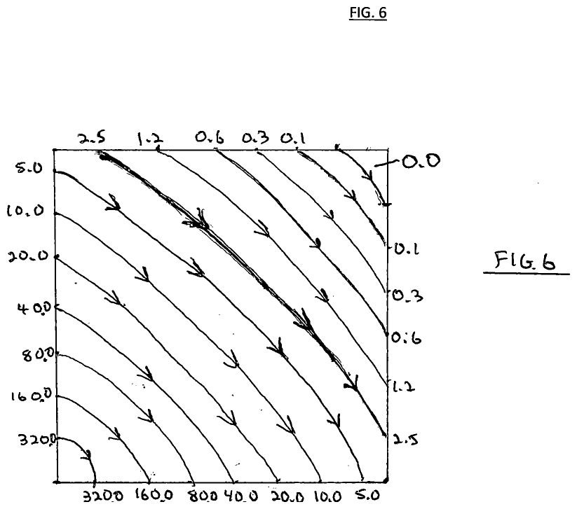

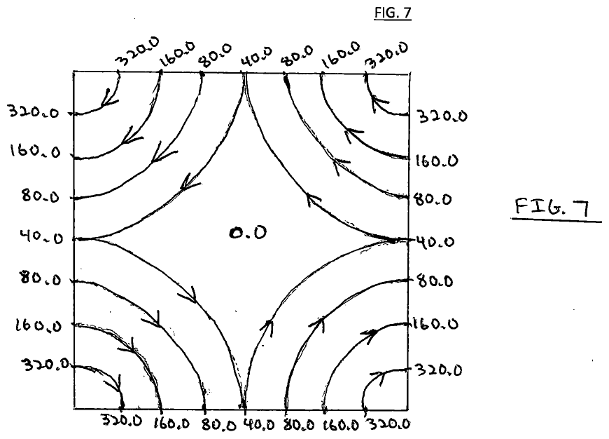

Powdered copper sulfate pentahydrate was added to a melt of lanthanum nitrate hexahydrate to saturation. The resulting mixture was heated to 90° C. and the liquid was separated from excess copper sulfate and placed into three separate containers. One container was immersed in a magnetic field as shown in FIG. 7. A second container was immersed in a magnetic field as shown in FIG. 6. The magnetic field was provided by a cubic cage of a permanent neodymium (Nd₂Fe₁₄B) magnet open at the top and bottom. The samples were immersed in the field so that the top of the liquid in the container was level with the top of the cage. The third container was not in any magnetic field. The solutions were allowed to slowly cool to room temperature. The sample in the second container, immersed in uniform-direction magnetic field as shown in FIG. 6, solidified prior to reaching room temperature. The samples in the other two containers remained in the liquid phase at room temperature. After a few hours, the sample in the isolated container, not immersed in any field during preparation, transitioned to the solid phase and released heat, with the temperature rising to 57° C. from room temperature. The sample in the container that had been immersed during preparation in the nonuniform-direction magnetic field, as shown in FIG. 7, remained in the liquid phase until it was disturbed by pouring it into another container after several days, whereupon it transitioned to the solid phase with a release of heat.

### Laboratory Example 2: Stabilization of the Liquid Phase of the Liquid Crystals

When samples that were prepared by immersion in a nonuniform-direction magnetic field (FIG. 7) transitioned to the solid phase, they were melted and a quantity of water was added to the liquid in proportions ranging from 0.14 g to 0.18 g of H₂O per gram of hydrated rare-earth metal nitrate contained in the liquid. These samples were allowed to slowly cool to room temperature. A portion of these samples was immersed again in the magnetic field shown in FIG. 7 as they cooled to room temperature, and another portion cooled in the absence of any magnetic field. All of the samples were permanently stabilized in the liquid phase.

Note that these liquids are not merely aqueous solutions of rare-earth metal nitrates and transitional metal salts. Each mole of La(NO)₃·6H₂O consists of approximately 325 grams of La(NO₃)₃ complexed with 108 grams of H₂O; therefore, 100 grams of La(NO₃)₃·6H₂O contains approximately 75 grams of La(NO₃)₃ and 25 grams of H₂O. Adding 0.14 g to 0.18 g of H₂O for every gram of La(NO₃)₃·6H₂O in a 100 gram sample of the melted solid adds 14 to 18 grams of water for a maximum total of 43 grams of water. Forty-three milliliters of water will not dissolve 75 grams of anhydrous lanthanum nitrate. Furthermore, 75 grams of anhydrous lanthanum nitrate would immediately combine with 25 grams of water to form the solid-state hydrated lanthanum nitrate, leaving 14 to 18 grams (or milliliters) of water to dissolve 100 grams of La(NO₃)₃·6H₂O, which is physically impossible. The compounds disclosed herein are truly inorganic liquid crystals and not merely aqueous solutions.

When the samples that were prepared by either immersion in a uniform-direction magnetic field (FIG. 6) or in the absence of any magnetic field transitioned to the solid phase, they were melted and a quantity of water was added to the melts. All of these samples separated, upon cooling to room temperature, into an aqueous solution of transition metal salt and a solid precipitate of hydrated rare-earth metal nitrate, regardless of the amount of water added to the melt.

### Laboratory Example 3: X-ray Crystallography

Sample 1 was prepared in accordance with Laboratory Example 1 and stabilized in the liquid phase, as described in Laboratory Example 2, by the addition of water to the liquid crystal in a ratio of 0.15 g of water to 1.00 g of the liquid crystal, after destabilization of the LC and its transition to the sold phase. Sample 2 is a portion of Sample 1 set aside and left in the solid phase without the addition of water. Sample 1, the liquid sample, was pipetted on a special zero-background sample holder while Sample 2 was placed onto an adjustable height sample stage of the diffractometer for analysis; then a dried quantity of Sample 1 and a quantity of the solid Sample 2 were placed on a special low-background cup for analysis. X-ray diffraction (XRD) data was collected by a two-theta scan on a Rigaku Smartlab diffractometer equipped with a copper X-ray tube with Ni beta filter, parafocusing (Bragg-Brentano) optics, computer-controlled slits, and a D/teX 1D strip detector. Crystalline phases (or systems), percent crystallinity, average crystallite size, and the crystal lattice constants for the tested samples are listed in Table 1 hereinabove.

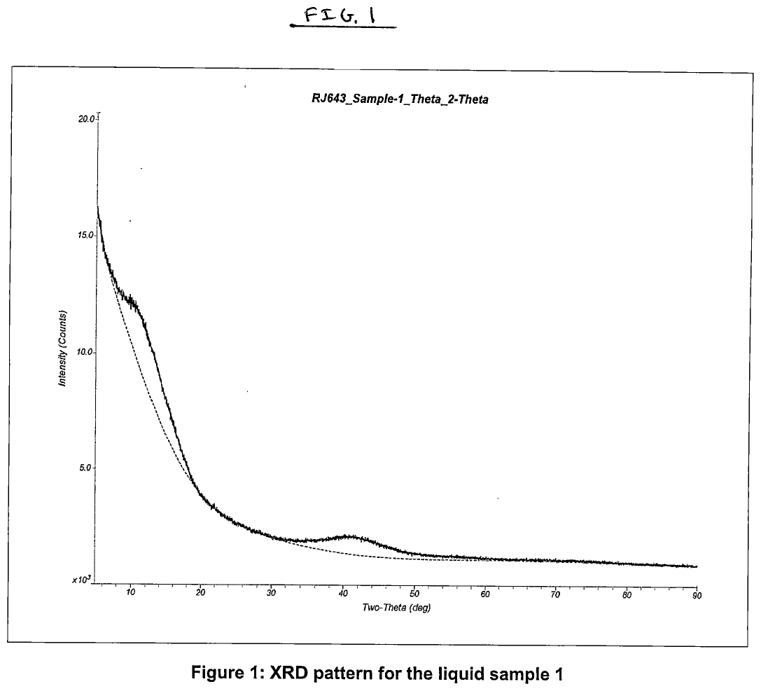

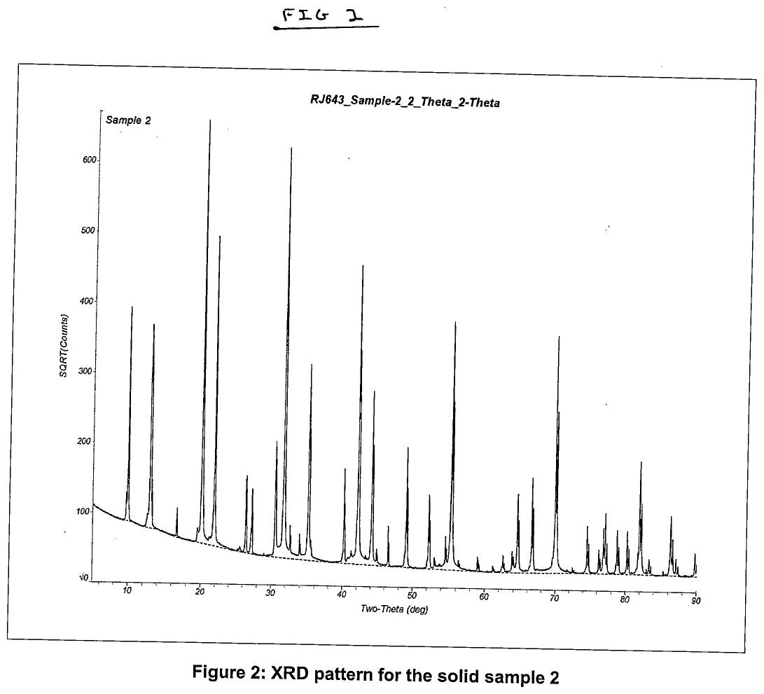

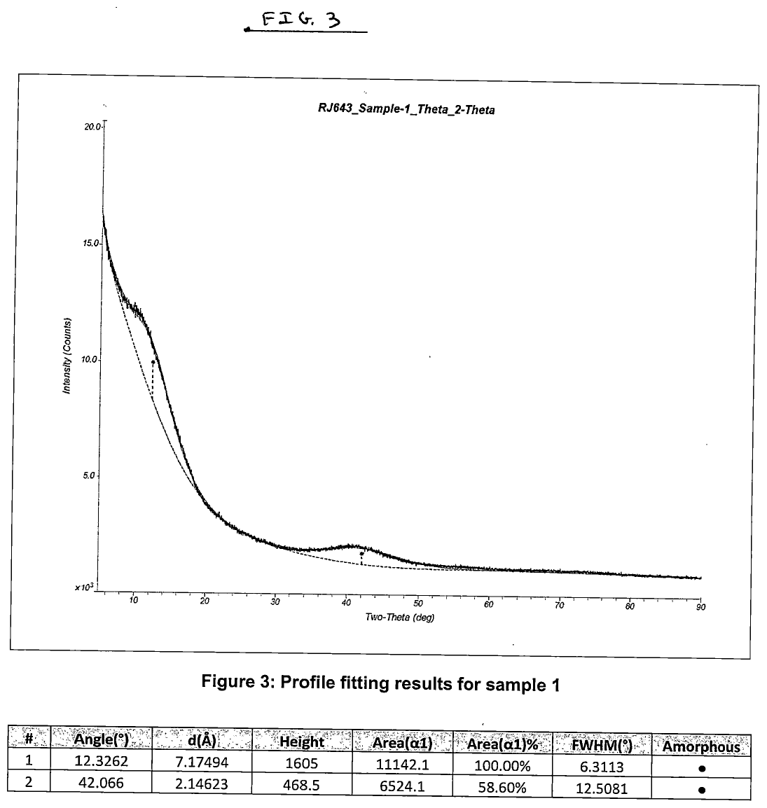

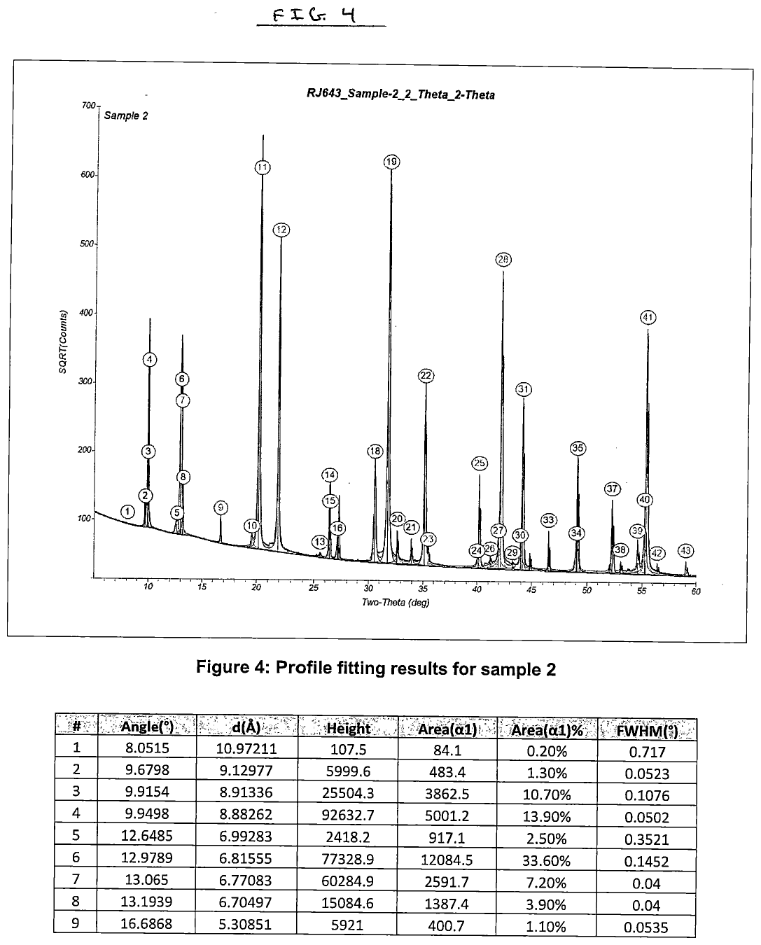

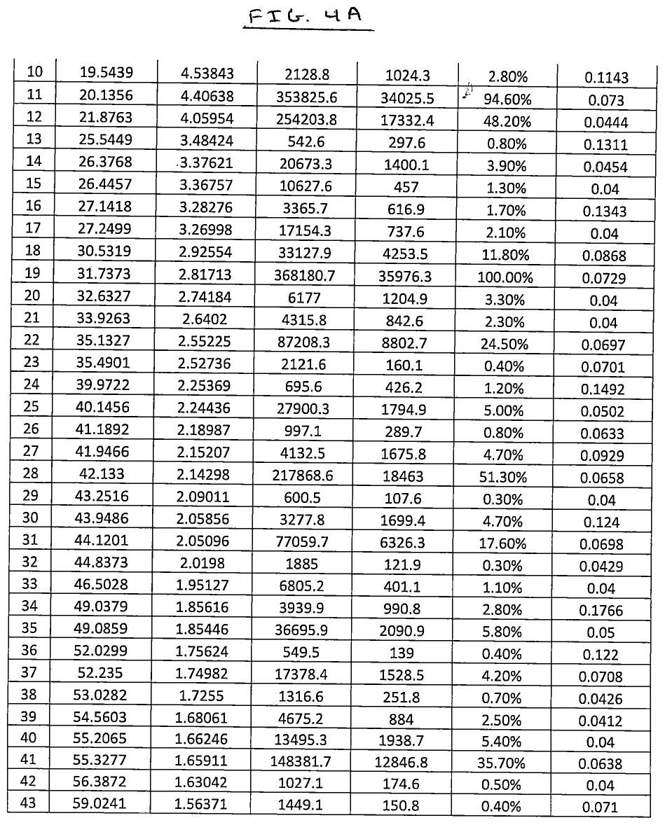

The two main broad peak shape in FIG. 1 indicates that the liquid Sample 1 is completely amorphous. The amorphous nature of Sample 1 is the expected result of the stabilization of the liquid phase by the addition of water to the liquid crystal in the preparation of the sample (see Laboratory Example 2). Because of the amorphous nature of Sample 1, there was no basis for comparison of the data of the sample to the ICDD or ICSD databases; however, the experimental data for Sample 2 (see FIG. 2), which was classified as crystalline by Eurofins EAG Materials, was compared to these databases, and no satisfactory matches were found, which supports the novelty of the materials in the present invention.

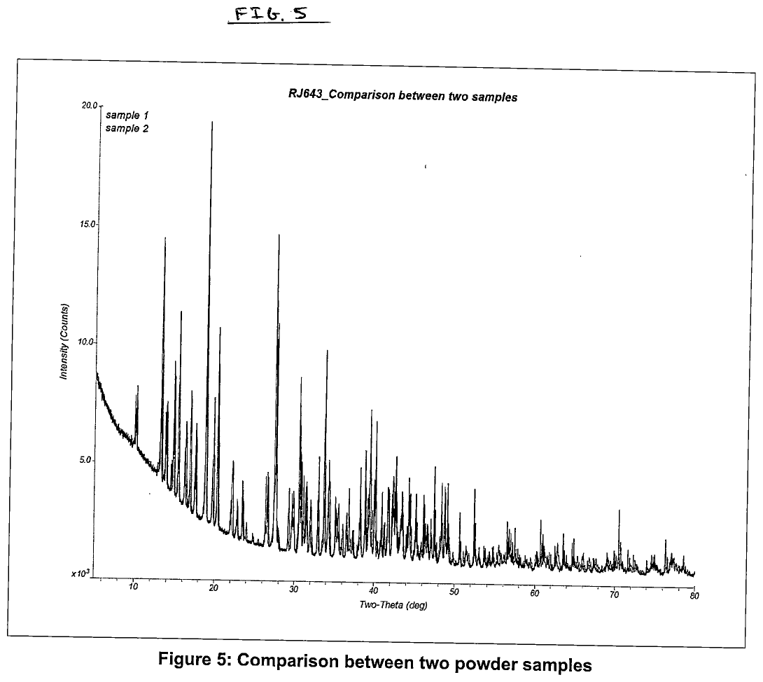

A quantity of the liquid Sample 1 was dried and ground into a powder. A comparison of raw XRD data from powdered Samples 1 and 2 (FIG. 5) show general similarity except for the difference in overall intensities and peak shape. These differences, when considered in conjunction with the significant difference in crystallite size (see Table 1), which was determined by modeling the peaks in the XRD patterns and translating the Full Width of Half Maximum (FWHM) of each peak directly to crystallite size, indicates that a contraction in the spacing of the crystal lattice planes occurs in the transition of the LC from the liquid to the solid phase upon destabilization. The dried and powdered Sample 1 exhibited an average crystallite size of 148.0+/−5.5 nM, and that for Sample 2 was 110.7+/−2.1 nM (see Table 1), a difference in excess of 37.0 nM. On the molecular and atomic scales, such a difference is substantial, and the contraction in the lattice plane spacing of the materials disclosed here could conceivably be applied to molecular assembly when the undiluted LCs are used as reaction media or scaffolding, especially under the influence of external magnetic or electrical fields.

Semi-quantitative analysis was performed using whole pattern fitting (WPF), which is a subset of Rietveld Refinement that accounts for all intensity above a background curve. During this process, structure factor (which relates to concentration), lattice parameters (which relate to XRD peak position), peak width and peak shape are refined for each phase to minimize the R value—an estimate of the agreement between the least square mean and the experimental data over the entire pattern. The R values for these refinements, at 10.34% for Sample 1 and 5.92% for Sample 2 are quite good and reasonable given such complex patterns, according to Eurofins EAG Material Science.

Crystalline phases (see Table 1) were identified by comparing the location and relative intensity of peaks present in background-modeled experimental XRD data to entries in the ICDD/ICSD databases. According to Eurofins EAG, the technique of XRD is sensitive to crystal structure but relatively insensitive to elemental or chemical state composition. The quantity of hydrated transition metal sulfate in the samples sent to Eurofins EAG was in a proportion of 1 to 40 by weight to the hydrated rare-earth metal nitrate (see Composition of the Preferred Embodiments hereinabove), and consequently its effect on the XRD results was negligible and the phase (or system) identified was the triclinic lanthanum nitrate hexahydrate, whose ICDD/ICSD reference pattern was superimposed on the experimental data (see Table 1) and determined to be the closest match for both samples.

1. An inorganic liquid crystal composed of two inorganic compounds: (a) a hydrated rare-earth metal nitrate with molecular formula R(NO₃)₃·6H₂O and (b) a hydrated transition metal sulfate with molecular formula TSO₄·nH₂O, wherein R is the cation with +3 electrical charge of one of the following rare-earth metals: yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), and ytterbium (Yb); T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

2. The liquid crystal in claim 1, wherein the transition metal component is a hydrated transition metal sulfate with molecular formula T₂(SO₄)₃·nH₂O; T is a cation with +3 electrical charge of iron (Fe) or chromium (Cr); and n=1 to 18.

3. The liquid crystal in claim 1, wherein the transition metal component is zirconium sulfate with molecular formula Zr(SO₄)₂·nH₂O and n=1 to 9.

4. The liquid crystal in claim 1, wherein the transition metal component is a hydrated transition metal chloride with molecular formula TCl₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

5. The liquid crystal in claim 1, wherein the transition metal component is a hydrated transition metal chloride with molecular formula TCl₃·nH₂O; T is a cation with +3 electrical charge of iron (Fe) or chromium (Cr); and n=1 to 9.

6. The liquid crystal in claim 1, wherein the transition metal component is zirconium chloride with molecular formula ZrCl₄·nH₂O and n=1 to 9.

7. The liquid crystal in claim 1, wherein the transition metal component is a hydrated transition metal fluoride with molecular formula TF₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

8. The liquid crystal in claim 1, wherein the transition metal component is a hydrated transition metal fluoride with molecular formula TF₁₃·nH₂O; T is a cation with +3 electrical charge of iron (Fe) or chromium (Cr); and n=1 to 9.

9. The liquid crystal in claim 1, wherein the transition metal component is zirconium fluoride with molecular formula ZrFl₄·nH₂O and n=1 to 9.

10. The liquid crystal in claim 1, wherein the transition metal component is a hydrated transition metal nitrate with molecular formula T(NO₃)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

11. The liquid crystal in claim 1, wherein the transition metal component is a hydrated transition metal nitrate with molecular formula T(NO₃)₃·nH₂O; T is a cation with +3 electrical charge of iron (Fe) or chromium (Cr); and n=1 to 9.

12. The liquid crystal in claim 1, wherein the transition metal component is zirconium nitrate with molecular formula Zr(NO₃)₄·nH₂O and n=1 to 9.

13. The liquid crystal in claim 1, wherein the transition metal component is a hydrated transition metal chlorate with molecular formula T(ClO₃)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

14. The liquid crystal in claim 1, wherein the transition metal component is a hydrated transition metal chlorate with molecular formula T(ClO₃)₃·nH₂O; T is a cation with +3 electrical charge of iron (Fe) or chromium (Cr); and n=1 to 9.

15. The liquid crystal in claim 1, wherein the transition metal component is zirconium chlorate with molecular formula Zr(ClO₃)₄·nH₂O and n=1 to 9.

16. The liquid crystal in claim 1, wherein the transition metal component is a hydrated transition metal perchlorate with molecular formula T(ClO₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

17. The liquid crystal in claim 1, wherein the transition metal component is a hydrated transition metal perchlorate with molecular formula T(ClO₄)₃·nH₂O; T is a cation with +3 electrical charge of iron (Fe) or chromium (Cr); and n=1 to 9.

18. The liquid crystal in claim 1, wherein the transition metal component is zirconium perchlorate with molecular formula Zr(ClO₄)₄·nH₂O and n=1 to 9.

19. The liquid crystal in claim 1 wherein the transition metal component is the hydrated transition metal selenite with molecular formula TSeO₃·nH₂O, wherein T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

20. The liquid crystal in claim 1, wherein the transition metal component is a hydrated transition metal selenite with molecular formula T₂(SeO₃)₃·nH₂O; T is a cation with +3 electrical charge of iron (Fe) or chromium (Cr); and n=1 to 18.

21. The liquid crystal in claim 1, wherein the transition metal component is zirconium selenite with molecular formula Zr(SeO₃)₂·nH₂O and n=1 to 9.

22. The liquid crystal in claim 1, wherein the transition metal component is a hydrated transition metal tetrafluoroborate with molecular formula T(BF₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

23. The liquid crystal in claim 1, wherein the transition metal component is a hydrated transition metal tetrafluoroborate with molecular formula T(BF₄)₃·nH₂O; T is a cation with +3 electrical charge of iron (Fe) or chromium (Cr); and n=1 to 9.

24. The liquid crystal in claim 1, wherein the transition metal component is zirconium tetrafluoroborate with molecular formula Zr(BF₄)₄·nH₂O and n=1 to 9.

25. The liquid crystal in claim 1, wherein the transition metal component is a hydrated transition metal arsenate with molecular formula T₃(AsO₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

26. The liquid crystal in claim 1, wherein the transition metal component is a hydrated transition metal arsenate with molecular formula TAsO3·nH₂O; T is a cation with +3 electrical charge of iron (Fe) or chromium (Cr); and n=1 to 9.

27. The liquid crystal in claim 1, wherein the transition metal component is zirconium arsenate with molecular formula Zr₃(AsO₄)₄·nH₂O and n=1 to 9.

28. The liquid crystal in claim 1, wherein the transition metal component is a hydrated transition metal phosphate with molecular formula T₃(PO₄)₂·nH₂O; T is a cation with +2 electrical charge of one of the following transition metals: manganese (Mn), cobalt (Co), nickel (Ni), copper (Cu), zinc (Zn), palladium (Pd), and cadmium (Cd); and n=1 to 9.

29. The liquid crystal in claim 1, wherein the transition metal component is a hydrated transition metal phosphate with molecular formula TPO3·nH₂O; T is a cation with +3 electrical charge of iron (Fe) or chromium (Cr); and n=1 to 9.

30. The liquid crystal in claim 1, wherein the transition metal component is zirconium phosphate with molecular formula Zr₃(PO₄)₄·nH₂O and n=1 to 9.

31. The method of preparation of the compositions in claims 1 to 30 wherein the hydrated rare-earth metal component is melted and serves as a solvent into which the solid-state hydrated transition metal component is dissolved to the point of saturation, and the liquid is separated from excess transition metal salt and placed in a magnetic field to slowly cool to room temperature.

32. The method of preparation in claim 31 wherein the magnetic field applied to the liquid during cooling is of specific geometry, as in FIG. 7 of the Drawings, such that the direction and magnitude of the magnetic field varies in different regions or domains of the liquid as it cools to room temperature.

33. The method of stabilizing the liquid phase of the preparations in claims 1 to 30, after the liquid becomes destabilized and transitions to the solid phase, by melting the solid and adding a quantity of water to the melt, not exceeding 18 grams of water to 100 grams of hydrated rare-earth metal nitrate in the melt, then allowing the resulting liquid to slowly cool to room temperature.

34. The method of preparation of liquid crystals, consisting solely of the hydrated rare-earth metal nitrates, as set forth in claim 1, either as a single component or as a combination of components, wherein the hydrated rare-earth metal nitrates are heated to melting, then the resulting liquid is immersed in a nonuniform magnetic field to slowly cool to room temperature, then the solid is melted a second time and a quantity of water is added to the melt in an amount not exceeding a ratio of 0.14 to 0.18 grams of water per gram of the hydrated rare-earth metal nitrate in the melt, such that the liquid phase is stabilized and no longer spontaneously transitions to the solid phase.

35. The use of the of the preparations in claims 1 to 30 or the methods in claims 31 to 34 in any process for the development or manufacturing of Type II superconductors, electrolytes, catalysts, or other materials with desirable magnetic, electrical, or chemical properties, where such use is a necessary part of the process.
